(19) United States
(12) Patent Application Publication
(10) Pub. No.: US 2003/0141878 A1
(43) Pub. Date: Jul. 31, 2003

(54) Continuity test unit and system

(75) Inventors: Tomohiro Shinzou, Yokkaichi-city (JP); Takuya Nojima, Yokkaichi-city (JP)

Correspondence Address: GREENBLUM & BERNSTEIN, P.L.C., 1950 ROLAND CLARKE PLACE, RESTON, VA, 20191, US

(73) Assignee: Sumitomo Wiring Systems, Ltd., Yokkaichi-city (JP)

(21) Appl. No.: 10/351,494

(22) Filed: Jan. 27, 2003

(30) Foreign Application Priority Data
Jan. 30, 2002 (JP) 2002-022001

(51) Int. Cl. H04B 3/46; H01H 31/02

(52) U.S. Cl. 324/539

(57) ABSTRACT

A housing holder is provided with detectors to be inserted into communication grooves of a connector. The detectors are electrically connected through a lead wire to a test device. The test device is also connected to an adapter electrically connected to a rear end of a probe on each terminal. During a continuity test, incomplete insertion or dropout of a terminal, and a short circuit between terminals are detected by comparing a circuitry formed by a contact of each terminal with the detector and probe with a circuitry stored in the memory of the test device beforehand.

### BACKGROUNG OF THE INVENTION

1. Field of the Invention

The present invention relates to a continuity test unit that detects incomplete insertion or dropout of a terminal in a connector housing, and detects a short circuit condition between terminals in a connector housing. The present invention also relates to a continuity test system including such a continuity test unit. In particular, the present invention relates to a continuity test unit that detects incomplete insertion or dropout of a terminal, and a short circuit condition between terminals, in an assembled-housing type connector, in which a plurality of connector housings are assembled in a single cover, and a continuity test system including such a continuity test unit.

2. Description of the Related Art

A wire harness is an electric wiring system in which a plurality of electric wires are connected to one another through connectors to form a predetermined circuit network. A connector to be used in a wire harness may include a housing made of a resin material and having cavities therein containing metallic terminals inserted into the cavities. In order to secure a terminal inserted into a cavity within the housing, an elastic projection, such as a lance, may be provided on either the terminal or the housing in a cantilever manner. Further, a latch recess for receiving the lance is provided in the other of the terminal or the housing. In one type of conventional connector, in order to fortify a locking structure between the terminal and the housing, a double latching mechanism, which may include an engaging member, such as a retainer, is provided in the housing.

After such a wire harness is produced, a continuity test is performed to inspect an electrical connection condition in each connector. One apparatus for performing such a test is disclosed in Japanese Patent Public Publication No. HEI 07-6593(1995).

Such a continuity test apparatus includes a connector holder for holding a connector having a housing containing terminals, a test section configured to move toward and away from the connector holder to test a continuity of the terminals, and a device for displacing the test section relative to the connector holder between a test position in which the test section is moved toward the connector holder and a rest position in which the test section is moved away from the connector holder. During testing, the connector is mounted in the connector holder and the displacement device is actuated to move the test section toward the connector holder. Thereby, each detector comes into contact with each respective terminal to test a continuity condition.

For testing a connector having a retainer, so-called double probe pins are used which applies a strong biasing force to the detector in the test section. A terminal which is not properly fitted and locked in the housing will be pushed out from the housing by the double probe pins.

Recently, an assembled-housing type connector has been developed, in which a plurality of connector housings are assembled together in a single cover. In order to carry out a continuity test of such an assembled-housing type connector, it is necessary to test a continuity of each separate housing before the respective housings are assembled in the cover (hereinafter referred to as a “primary test”), and to further test a continuity of the entire connector assembly after the housings are mounted in the cover (hereinafter referred to as a “secondary test”).

In the above assembled-housing type connector, the housings are provided on their outer sidewalls with communication grooves communicating with the cavities in the housing for assembling the housings in the cover. Ribs provided on the cover engage the communication grooves during assembly to serve as retainers. Accordingly, during the primary test of the housing, there is not yet a retainer in the housing, and therefore it is not possible to use the double probe pin type detector. Consequently, incomplete insertion of the terminals cannot be detected during the primary test.

If a core element of an electric wire connected to a terminal extends from the communication groove, a short circuit condition may occur between the electric wires when the housing is assembled in the cover. Further, if incomplete insertion of terminals is not detected until the secondary test is performed (i.e., after the housings have been assembled in a cover), the number of steps required for reworking the connector will be increased.

### SUMMARY OF THE INVENTION

In view of the above problems, an object of the present invention is to provide a continuity test unit that can detect a defect in a connector housing during a primary test, prior to assembly of the housing in a cover, and a continuity test system using the unit.

To achieve the foregoing object, according to the present invention, a continuity test unit for testing a connector in which a housing is assembled in a cover is provided. The housing includes plural cavities for receiving terminals connected to electric wires, and a communication groove extending in a direction perpendicular to an insertion direction of the terminals for exposing the cavities to an exterior of the housing. The cover includes a retainer for engaging the communication groove of the housing.

The continuity test unit includes a housing holder, a continuity test section, and a displacement device. The housing holder is configured to hold a housing during testing before the housing is assembled in a cover. The continuity test section is configured to move toward and away from the housing holder, and includes plural probes for contacting and establishing electrical connection with respective terminals in a housing held in the housing holder. The displacement device is configured to move the continuity test section relative to the housing holder, between a test position in which the continuity test section is displaced toward the housing holder to contact the probes with the respective terminals in the housing, and a loading position in which the continuity test section is displaced away from the housing holder to allow for loading and removal of housings from the housing holder. The housing holder includes a conductive detector configured to be inserted into the communication groove in the housing adjacent to the cavities for detection of a short circuit condition.

In this construction, a housing is placed in the housing holder while the test section is in the loading position, and before the housing is mounted in the cover. The conductive detector enters the communication grooves in the housing. Next, the displacement device moves the test section toward the housing holder and into the test position. In the connector being tested, since the conductive detector enters the communication groove designed to receive the retainer on the cover, the detector will come into contact with any core element of the electric wire extending into the communication groove, or any improperly inserted terminal extending into the communication groove, thereby electrically detecting a defect condition.

Further, in the continuity test unit according to the present invention, the housing holder is configured to hold a plurality of the housings for simultaneous testing of the plurality of housings. In this construction, the continuity test of the housings can be carried out while simulating the condition in which the housings are mounted in the cover.

Further, in the continuity test unit according to the present invention, the conductive detector of the housing holder and the communication groove of the housing have complementary L-shaped cross-sections.

Further, in the continuity test unit according to the present invention, the continuity test section includes a chamber in which the probes are positioned.

Further, in the continuity test unit according to the present invention, the displacement device includes a handle for moving the continuity test section.

Further, in the continuity test unit according to the present invention, a base plate supports the housing holder, the continuity test section, and the displacement device.

Further, in the continuity test unit according to the present invention, each of the terminals is crimped onto a core of an electric wire, and the conductive detector detects a crimping defect condition of a terminal received in a housing cavity.

Further, in the continuity test unit according to the present invention, each of the terminals includes a latch pawl, and each of the cavities includes a latch hole configured to receive a latch pawl of a terminal for locking the terminal in the cavity. The conductive detector detects a condition in which the latch pawl of a terminal is not received in the latch hole of a cavity.

Further, the continuity test unit according to the present invention is configured for testing a connector in which a plurality of the housings are assembled in a single cover.

Further, in the continuity test unit according to the present invention, the housing includes a plurality of the communication grooves, and the housing holder includes a plurality of the conductive detectors.

In another aspect of the present invention, a continuity test system is provided which includes the above described continuity test unit. The continuity test system also includes a continuity test circuit electrically connected to the probes provided in the continuity test section of the continuity test unit for testing a connection condition of terminals contacted by the probes. Further, the conductive detector of the housing holder of the continuity test unit is electrically connected to the continuity test circuit to determine whether a short circuit condition exists.

Further, in the continuity test system according to the present invention, the housing holder is configured to hold a plurality of the housings for simultaneous testing of the plurality of housings.

Further, in the continuity test system according to the present invention, the continuity test unit is configured for testing a connector in which a plurality of the housings are assembled in a single cover.

Further, in the continuity test system according to the present invention, the housing includes a plurality of the communication grooves, and the housing holder includes a plurality of the conductive detectors.

Further, the continuity test system according to the present invention includes a plurality of the continuity test units.

In this construction, it is possible to detect the connection conditions of the respective terminals with the respective probes connected to the continuity test circuit. Since the conductive detectors are connected to the continuity test circuit to determine whether any short circuit condition occurs, it is possible for the continuity test circuit to decide which pole the conductive detector contacts. Consequently, it is possible to identify the terminal in a short circuit or dropout condition, as well as to carry out the continuity test, by displacing the continuity test section to the test position and performing the continuity test of the respective terminals in the housing.

### BRIEF DESCRIPTION OF THE DRAWINGS

The above, and other objects, features and advantages of the present invention will be made apparent from the following description of the preferred embodiments, given as nonlimiting examples, with reference to the accompanying drawings in which:

FIG. 1 is an exploded perspective view of an assembled-housing type connector in accordance with the present invention;

FIG. 2 is a perspective view of a housing provided in the connector shown in FIG. 1;

FIG. 3 is an enlarged cross-sectional view of a portion of the connector shown in FIG. 1, illustrating the relationship between a housing, a terminal, and a cover in the connector;

FIG. 4 is a perspective schematic view of a continuity test system in accordance with the present invention, illustrating the relationship between a continuity test unit and the continuity test system including the unit;

FIG. 5 is a perspective schematic view of the continuity test unit shown in FIG. 4;

FIG. 6 is an exploded perspective view of the continuity test unit shown in FIG. 4;

FIG. 7 is a schematic circuit diagram of the continuity test unit and continuity test device shown in FIG. 4;

FIG. 8A is a cross-sectional side elevation view of the continuity test unit shown in FIG. 4, illustrating a test section spaced away from a housing holder;

FIG. 8B is a cross-sectional side elevation view of the continuity test unit shown in FIG. 4, illustrating the test section displaced toward the housing holder;

FIG. 9A is an enlarged cross-sectional view of a connector housing mounted in a housing holder of a continuity test unit, illustrating a normal condition;

FIG. 9B is an enlarged cross-sectional view of a connector housing mounted in a housing holder of a continuity test unit, illustrating a defect condition due to incomplete insertion or dropout of the terminal; and

FIG. 9C is an enlarged cross-sectional view of a connector housing mounted in a housing holder of a continuity test unit, illustrating a crimping-defect condition of the sheathed electric wire.

### DETAILED DESCRIPTION OF THE PREFERRED EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

An embodiment of the present invention will be described below with reference to the drawings.

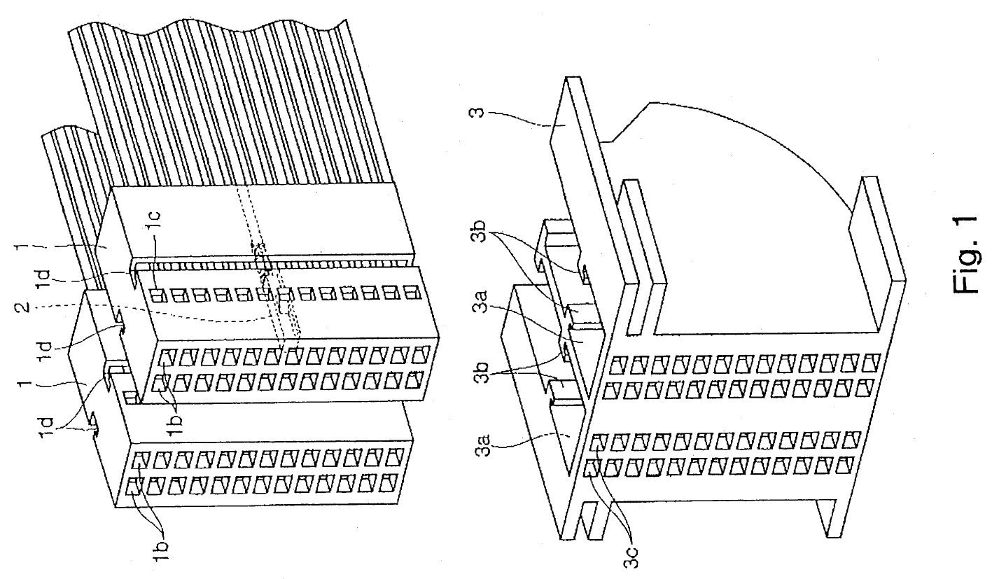

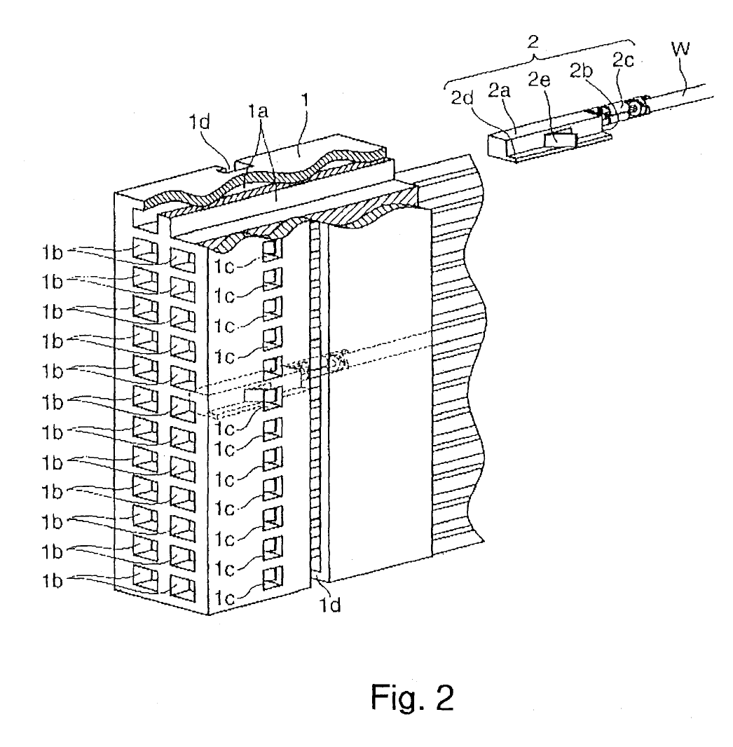

FIG. 1 is an exploded perspective view of an embodiment of an assembled-housing type connector in accordance with the present invention, illustrating a schematic construction of the connector partially cut away. FIG. 2 is a perspective view of a housing used in the connector shown in FIG. 1.

As shown in FIGS. 1 and 2, the connector includes two housings 1 made of any suitable material, such as molded synthetic resin. Terminals 2 made of any suitable material, such as metal, are inserted into the housings 1. A cover 3 made of any suitable material, such as molded synthetic resin, contains the two housings 1. However, it is noted that the cover could be configured to contain more than two housings in accordance with the present invention.

As shown in FIG. 2, each housing 1 includes cavities 1a into each of which a terminal 2 is inserted, connection holes 1b for electrically coupling the respective terminals 2 to a mating connector, latch holes 1c for latching the respective terminals 2 in the housing 1, and communication grooves 1d. Each communication groove 1d is formed into an L-shape in cross section to communicate the respective cavities 1a with an exterior of the housing 1.

Each terminal 2 has a terminal body 2a made of any suitable material, such as metal. The terminal body 2a includes a front end surface to be directed to the communication hole 1b in the housing 1 and a rear end surface 2b provided with a barrel 2c for a core element. The barrel 2c is crimped onto the core element in a sheathed electric wire W. The terminal body 2a is provided on a side surface with a stabilizer 2d for positioning the terminal 2 during insertion into the housing 1. Further, the terminal body 2a is provided on a middle portion of the side surface with a latch pawl 2e.

When the terminal 2 is inserted into the cavity 1a, the latch pawl 2e of the terminal 2 passes through the communication groove 1d in the housing 1 and engages the latch hole 1c. This engagement locks the terminal 2 in the housing 1.

Referring to FIG. 1, the cover 3 includes housing-containing chambers 3a, engaging ribs 3b, and terminal connection holes 3c. The housing-containing chambers 3a are juxtaposed in the cover 3 to contain two parallel housings 1. The engaging ribs 3b project inwardly from inner side walls of the housing-containing chambers 3a to engage the communication grooves 1d in the housings 1. The terminal connection holes 3c communicate the housing-containing chamber 3a with an exterior of the cover 3 at positions corresponding to the connection holes 1b of a housing 1 inserted in the cover 3.

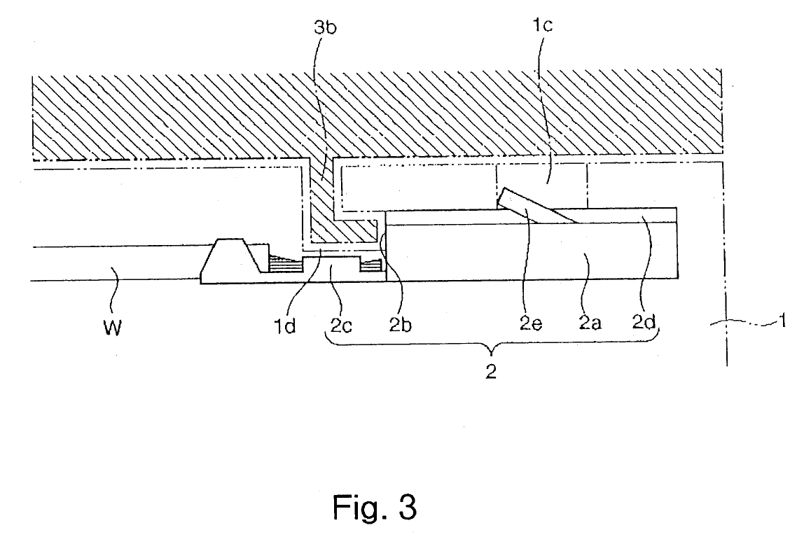

FIG. 3 is an enlarged sectional view of a portion of the connector shown in FIG. 1, illustrating a relationship betweeen a housing 1, terminal 2, and cover 3 in the connector. By referring now to FIG. 3, the connector will be described below.

When the respective housings 1 are accommodated in the cover 3, the engaging ribs 3b engage the communication grooves 1d. This engagement will establish a strong double engagement structure between the housing 1 and the terminals 2. That is, since the distal ends of the engaging ribs 3b support the rear end surfaces 2b of the terminals 2, the terminals 2 are locked in the housing 1 in a non-dropout condition. Also, engagement of the ribs 3b with the communication grooves 1d secures the housings 1 in the cover 3. Consequently, the respective housings 1 accommodated in the cover 3 can be handled as if they are a single connector.

In order to produce a wire harness including a connector as descibed above, it is necessary to carry out a primary test for testing a continuity of the respective housings 1 before assembling the respective housings 1 in the cover 3, and a secondary test for testing a continuity of the entire connector after assembling the respective housings 1 in the cover 3.

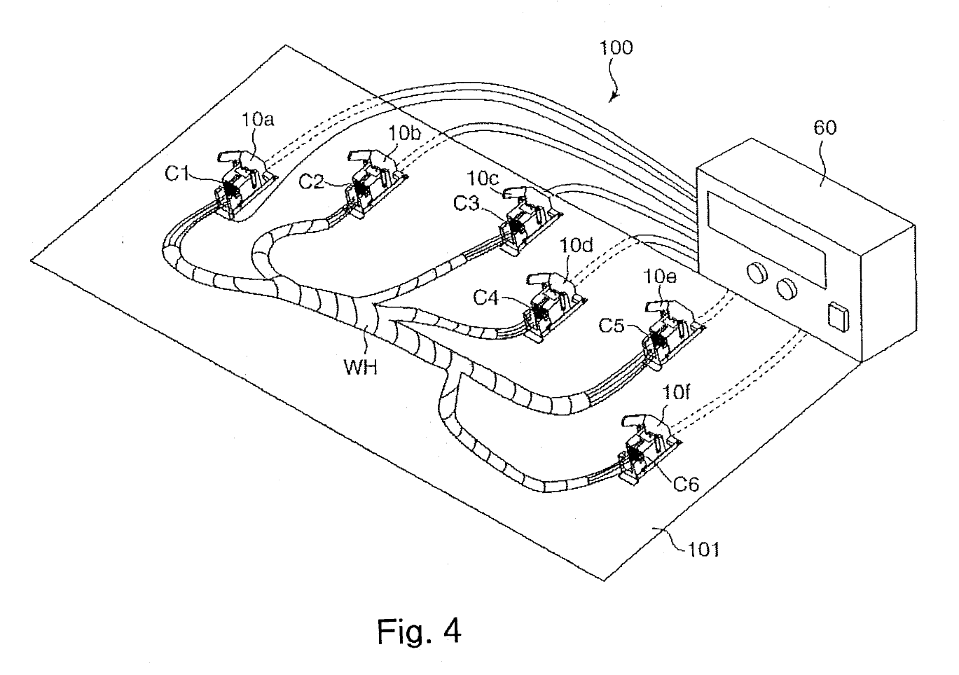

FIG. 4 is a perspective schematic view of an embodiment of a continuity test system 100 in accordance with the present invention, illustrating a relationship between continuity test units 10a-10f and a continuity test device 60.

The continuity test system 100 of the present invention is constructed as an inspection system for a wire harness WH in an electric wiring system for inspecting continuity in the wire harness WH. The wire harness WH is an electric wiring system forming a given circuit network. Connectors C1-C6 are selected in accordance with a specification of the wire harness WH. In the present embodiment, the connectors C1-C6 are of the type described above with reference to FIGS. 1-3, which each include two housings 1.

In the illustrated embodiment, the continuity test system 100 is disposed on a drawing board 101 and comprises a plurality of continuity test units 10a-10f for the plural connectors C1-C6 on the wire harness WH, and a continuity test device 60 connected to the respective continuity test units 10a-10f. However, it is noted that the provision of six connectors and six test units is merely for purposes of example, and that any number of connectors and test units could be provided, depending on the specification of the wire harness WH.

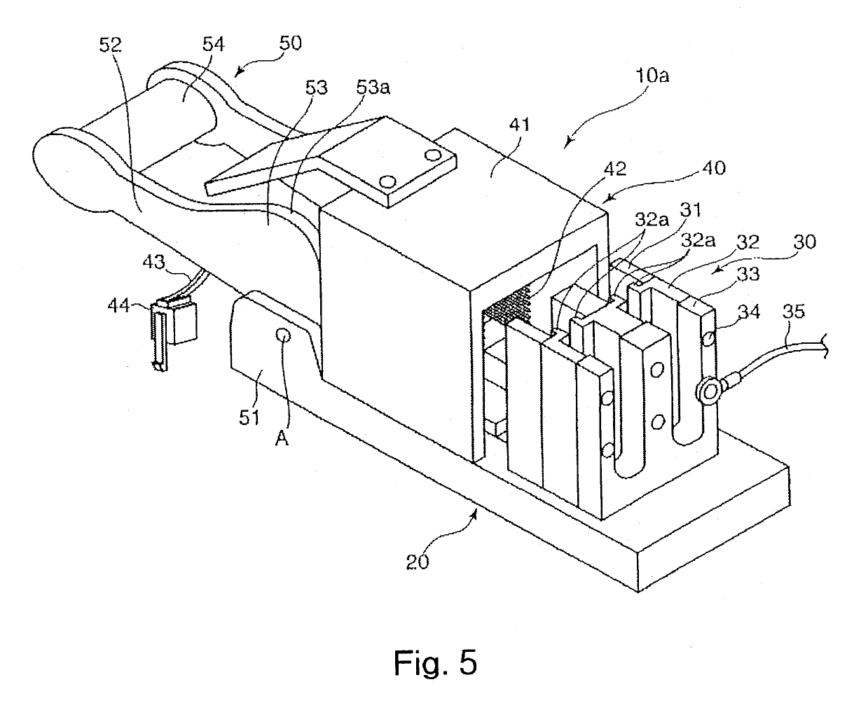

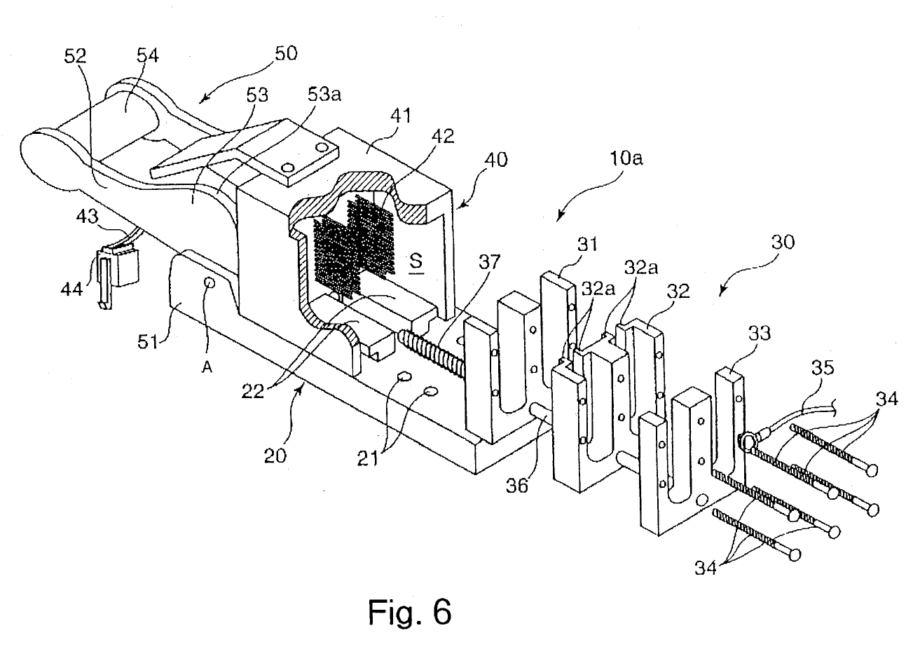

FIG. 5 is a perspective schematic view of the continuity test unit 10a shown in FIG. 4. FIG. 6 is an exploded perspective view of the continuity test unit 10a shown in FIG. 4.

The continuity test unit 10a includes a substantially rectangular plate-like base 20 made of any suitable material, such as synthetic resin, a housing holder 30 mounted on an end of the base 20 for holding two housings 1, a test section 40 movably mounted on the base 20 adjacent the housing holder 30 so that the test section 40 can move forward and backward relative to the housing holder 30 on the base 20, and a toggle mechanism 50 disposed on the base 20 for displacing the test section 40 relative to the housing holder 30. For convenience of explanation, the end surface of the base 20, on which the housing holder 30 is fixed, is hereinafter referred to as the “front side” in the longitudinal direction of the base 20 and as the “upper side” in the thickness direction of the base 20.

As shown in FIG. 6, the housing holder 30 includes a rear end portion 31, a middle portion 32, a front end portion 33, and bolts 34 coupling the portions 31-33 to one another. Each bolt 34 is screwed into the housing holder 30, with at least one passing through a lead wire 35.

The rear end portion 31 is an E-shaped plate made of any suitable material, such as synthetic resin and having openings on the top.

The middle portion 32 is an E-shaped plate made of any suitable conductive material, such as metal, and having openings on the top. The middle portion 32 is provided on a rear portion thereof with detectors 32a. When the housings 1 are mounted in the housing holder 30, the detectors 32a engage the communication grooves 1d in the housings 1.

The front end portion 33 is an E-shaped plate made of any suitable material, such as synthetic resin, and having openings on the top.

The bolts 34 are made of any suitable conductive material, such as metal, and are electrically connected to the holder middle portion 32 during screwed engagement. One end of the lead wire 35 is electrically connected to a bolt 34 and the other end is connected to the test device 60 for detecting terminals 2 causing a short circuit or a dropout.

A slide pin 36 is pushed into, and extends from, the housing holder 30. A compression coil spring 37 is mounted around the slide pin 36. A rear end portion of the slide pin 36 is slidably inserted into the test section 40. The compression coil spring 37 is compressed between the housing holder 30 and the test section 40 to bias the test section 40 backward.

The housing holder 30 is secured on the base 20 by screwing bolts (not shown) into screwed holes 21.

As shown in FIGS. 5 and 6, the test section 40 includes a block 41 made of any suitable material, such as synthetic resin, by any suitable process, such as molding or machining. The block 41 is substantially a cuboid and has a probe chamber S opened at the front end. Probes 42 are disposed in the probe chamber S at a position corresponding to the housings 1 to be contained in the housing holder 30. Rear ends of the probes 42 are connected through lead wires 43 to an adapter 44. The adapter 44 is connected to the continuity test device 60 to test a continuity condition of each terminal 2.

A lower portion of the test section 40 slidably engages hook-like rails 22. Accordingly, the test section 40 can move forward and backward in a longitudinal direction of the base 20 without moving upward.

A toggle mechanism 50, which is a displacement device in the continuity test unit 10a, includes a pair of supports 51 which extend upward at the rear end of the base 20. A handle 52 is rotatably supported through an axle A on the supports 51. The handle 52 includes a cam-like pressing portion 53 that comes into contact with the rear end portion of the test section 40 adjacent the axle A, and a handle grip 54 for operation by a user. A pressing surface 53a is formed on the periphery of the pressing portion 53. The block 41 of the test section 40 is always pushed against the pressing surface 53a by a biasing force exerted in the compression coil spring 37.

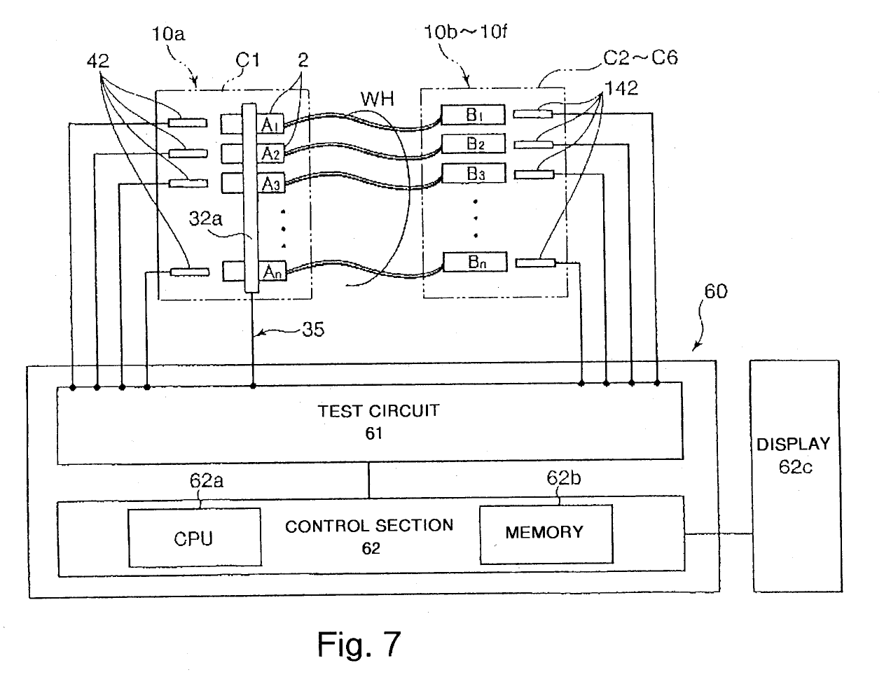

FIG. 7 is a schematic circuit diagram of the continuity test unit 10a and continuity test device 60. As shown in FIG. 7, the continuity test device 60 in the present embodiment includes a test circuit 61 connected to the respective continuity units 10a-10f and a control section 62 for controlling the test circuit 61.

The test circuit 61 is configured in a manner similar to a conventional continuity test machine. Each probe 42 of the continuity test unit 10a for testing the connector C1 is electrically connected to the test circuit 61 in the same manner as the probes 142 of the other continuity test units 10b-10f. Thus, the test circuit 61 transmits a test signal to the wire harness WH in accordance with instructions from the control section 62 to test a continuity of the wire harness WH. Furthermore, the detectors 32a in the continuity test unit 10a are electrically connected to the test circuit 61 by the lead wire 35.

The control section 62 includes a CPU (Central Processing Unit) 62a, a memory 62b connected to the CPU 62a, and a display 62c for displaying information to be processed and processed results.

A program for a continuity test that the CPU 62a carries out during continuity test processing is stored in the memory 62b. The memory 62b is used as an operation area for the CPU 62a. Furthermore, the memory 62b stores test data representing continuity information for contacts of a circuit network to be formed in the wire harness WH to be tested, and records read-out information as test data results.

In the above test program, the lead wire 35 is set to normally be in a non-contact condition (or non-continuity condition) with the terminals 2.

Accordingly, when the test circuit 61 inspects a connection condition of the wire harness WH in accordance with the test program, a continuity between the terminals 2 in connectors at different ends of a wire harness WH (i.e., A1 and B1; A2 and B2; A3 B3, . . . , and An and Bn) is inspected as in a conventional continuity test. Further, the presence of any short circuit between the wire harness and another circuit is also inspected for in the wire harness. In addition, since any terminal 2 in a housing 1 comes into contact with the detector 32a when dropout of the terminal, or extension of a core element, occurs in the housing 1, the lead wire 35 is brought into a short circuit condition with the corresponding terminal circuit, thereby detecting an abnormal condition.

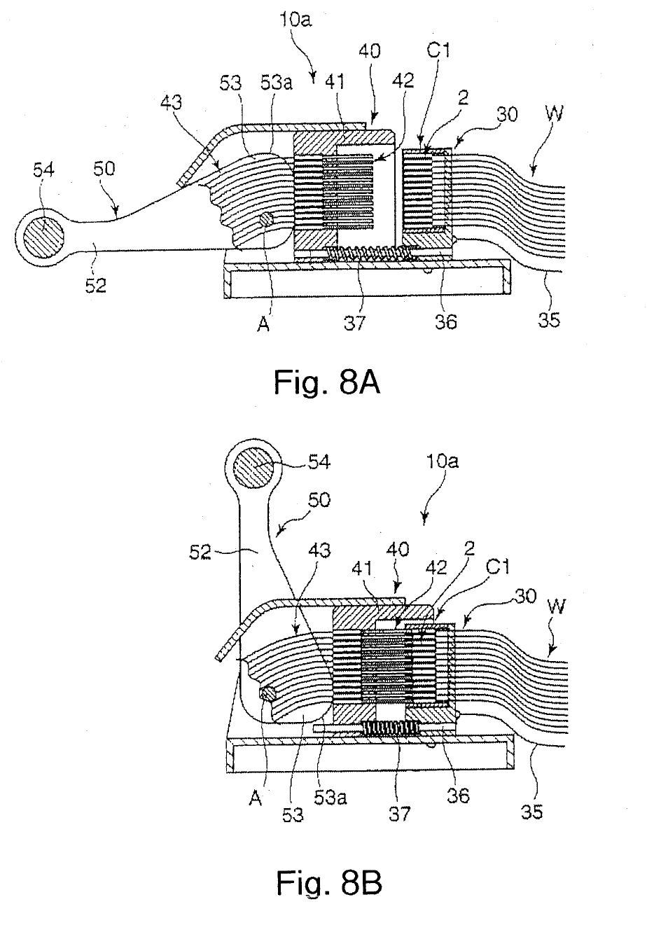

FIG. 8A is a sectional side elevation view of the continuity test unit 10a, illustrating a test section 40 spaced away from the housing holder 30 (hereinafter referred to as a loading or release position). FIG. 8B is a sectional side elevation view of the continuity test unit 10a, illustrating the test section 40 displaced toward the housing holder 30 (hereinafter referred to as a test position).

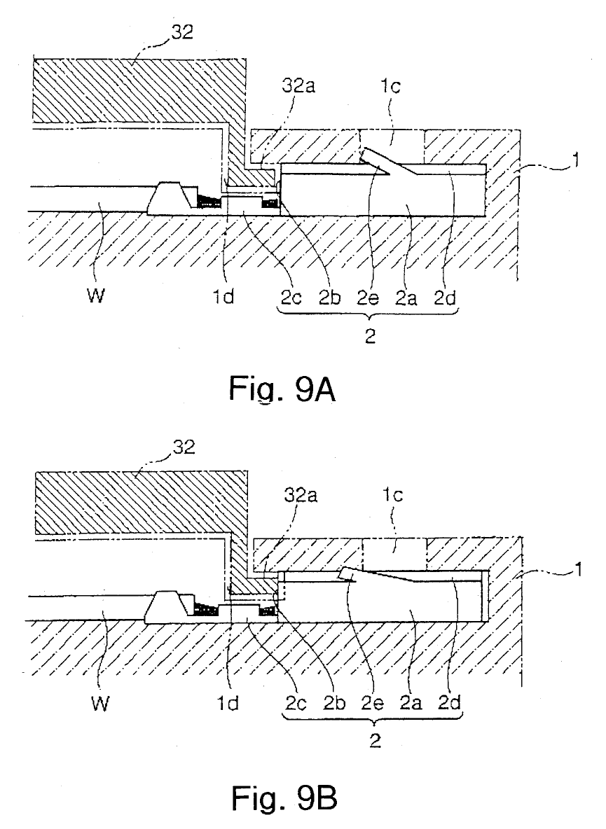

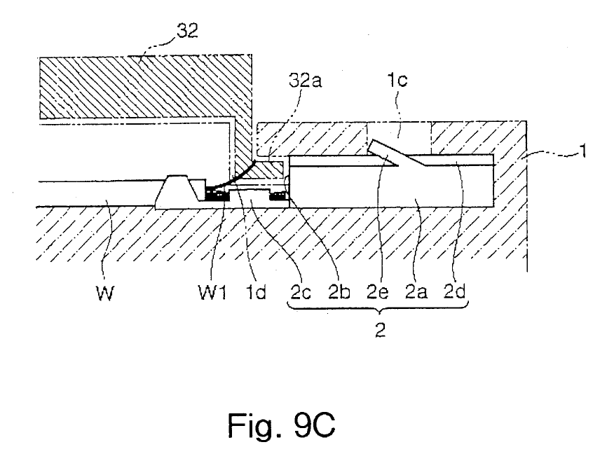

FIG. 9A is an enlarged sectional view of a connector housing 1 mounted in a housing holder 30, illustrating a normal condition. FIG. 9B is an enlarged sectional view of a connector housing 1 mounted in a housing holder 30, illustrating a defect condition due to incomplete insertion or dropout of the terminal. FIG. 9C is an enlarged sectional view of a connector housing I mounted in a housing holder 30, illustrating a crimping-defect condition of the sheathed electric wire W.

By referring now to FIGS. 7, 8A, 8B, 9A, 9B and 9C, an operation of the continuity test unit 10a will be explained below.

In the loading or release position shown in FIG. 8A, the test section 40 is spaced away from the housing holder 30, allowing a worker to mount a housing 1 in the housing holder 30. When the handle 52 is turned to a clockwise direction about the axle A, the block 41 is pushed forward toward the housing holder 30. When the handle 52 is turned by a predetermined angle, the block 41 is locked in a toggle manner in conjunction with the axle A and the continuity test unit 10a is locked in the test position shown in FIG. 8B.

In the test position, each probe 42 of the continuity test unit 10a comes into contact with the corresponding terminal 2 of the connector C1 to carry out the continuity test. Detection of a short circuit between the terminals and incomplete insertion or dropout of a terminal is performed simultaneously with the continuity test by the lead wire 35 connected to the detectors 32a.

In the condition shown in FIG. 9A, since the detector 32a does not contact the rear end surface 2b of the terminal 2, the detector 32a is not electrically connected to the respective terminals 2. Since the memory 62b of the test device 60 shown in FIG. 7 determines that a circuitry is acceptable if the detector 32a does not contact with the respective terminals 2, the display 62c indicates that the condition shown in FIG. 9A suggests an acceptable product.

In the condition shown in FIG. 9B, the latch pawl 2c of the terminal 2 does not engage the latch hole 1c, thus the terminal is not completely inserted, and may drop out from the housing 1. In this condition, since the detector 32a comes into contact with the rear end surface 2b, the detector 32a is electrically connected to the terminal 2. This circuitry is different from the acceptable circuitry stored in the memory 62b of the test device 60. Consequently, the dropout terminal 2 is identified in the condition shown in FIG. 9B and the display 62c indicates that the connector C1 being tested is an unacceptable product.

Furthermore, in the condition shown in FIG. 9C, a core element W1 of the sheathed electric wire W extends into the communication groove 1d due to a crimping defect between the terminal 2 and the wire W. Since the detector 32a is electrically connected to the terminal 2 in this condition, as in the condition shown in FIG. 9B, the display 62c indicates that the connector C1 is an unacceptable product. The core element W1 may contact an adjacent terminal 2 when the detector 32a is mounted causing a short circuit condition between the adjacent terminals 2. In this case, the terminals 2 in the short circuit are identified and the display 62c indicates that the connector C1 being tested is an unacceptable product.

Two connector housings 1 having the same outer configuration but different internal circuitries may be mounted in the housing holder 30. That is, two housings 1 having different internal circuitries may be fitted in the cover 3 to form a connector. In this case, it is possible to detect housings having different internal circuitries to be mounted in the housing holder 30 by storing two different circuitries in the memory 62b beforehand.

When the continuity test is finished, a worker turns the handle 52 in a counterclockwise direction. The biasing force exerted by the compression coil spring 37 pushed the test section 40 backward away from housing holder 30 to the loading or release position shown in FIG. 8A. Then, the worker removes the tested connector housings 1 from the housing holder 30.

In the continuity test system 100 described above, the detectors 32a to be fitted in the communication grooves 1d are provided in the housing holder 30. The detectors 32a are electrically connected to the test device 60. In the continuity test (primary test) of the housing 1 before the housing 1 is inserted into the cover 3, it is possible to electrically detect a fitting fault of terminals 2 in the housing 1 or a short circuit between the terminals 2.

In the test device 60 described above, since it is possible to specify a connection condition or a short circuit condition of an individual terminal, it is easy to rework the terminal as well as to identify defective terminals.

Although the invention has been described with reference to an exemplary embodiment, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed. Rather, the invention extends to all functionally equivalent structures, methods, and uses such as are within the scope of the appended claims.

The present disclosure relates to subject matter contained in priority Japanese Patent Application No. 2002-022001 filed on Jan. 30, 2002, which is herein expressly incorporated by reference in its entirety.

What is claimed:

1. A continuity test unit for testing a connector in which a housing is assembled in a cover, the housing including plural cavities for receiving terminals connected to electric wires, and a communication groove extending in a direction perpendicular to an insertion direction of the terminals for exposing the cavities to an exterior of the housing, the cover including a retainer for engaging the communication groove, said continuity test unit comprising:
a housing holder configured to hold a housing during testing before the housing is assembled in a cover;
a continuity test section configured to move toward and away from said housing holder, said continuity test section including plural probes for contacting and establishing electrical connection with respective terminals in a housing held in said housing holder; and
a displacement device configured to move said continuity test section relative to said housing holder between a test position in which said continuity test section is displaced toward said housing holder to contact the probes with the respective terminals in the housing, and a loading position in which said continuity test section is displaced away from said housing holder to allow for loading and removal of housings from said housing holder;
said housing holder including a conductive detector configured to be inserted into the communication groove in the housing adjacent to the cavities for detection of a short circuit condition.

2. The continuity test unit according to claim 1, wherein said housing holder is configured to hold a plurality of the housings for simultaneous testing of the plurality of housings.

3. The continuity test unit according to claim 1, wherein the conductive detector of said housing holder and the communication groove of the housing have complementary L-shaped cross-sections.

4. The continuity test unit according to claim 1, wherein said continuity test section includes a chamber in which the probes are positioned.

5. The continuity test unit according to claim 1, wherein said displacement device includes a handle for moving said continuity test section.

6. The continuity test unit according to claim 1, further comprising a base plate for supporting said housing holder, said continuity test section, and said displacement device.

7. The continuity test unit according to claim 1, wherein each of the terminals is crimped onto a core of an electric wire, and the conductive detector detects a crimping defect condition of a terminal received in a housing cavity.

8. The continuity test unit according to claim 1, wherein each of the terminals includes a latch pawl, each of the cavities includes a latch hole configured to receive a latch pawl of a terminal for locking the terminal in the cavity, and the conductive detector detects a condition in which the latch pawl of a terminal is not received in the latch hole of a cavity.

9. The continuity test unit according to claim 1, wherein the continuity test unit is configured for testing a connector in which a plurality of the housings are assembled in a single cover.

10. The continuity test unit according to claim 1, wherein the housing includes a plurality of the communication grooves, and said housing holder includes a plurality of the conductive detectors.

11. A continuity test system comprising:
a continuity test unit according to claim 1; and
a continuity test circuit electrically connected to the probes provided in said continuity test section of said continuity test unit for testing a connection condition of terminals contacted by the probes;
wherein the conductive detector of said housing holder of said continuity test unit is electrically connected to said continuity test circuit to determine whether a short circuit condition exists.

12. The continuity test system according to claim 11, wherein said housing holder is configured to hold a plurality of the housings for simultaneous testing of the plurality of housings.

13. The continuity test system according to claim 11, wherein said continuity test unit is configured for testing a connector in which a plurality of the housings are assembled in a single cover.

14. The continuity test system according to claim 11, wherein the housing includes a plurality of the communication grooves, and said housing holder includes a plurality of the conductive detectors.

15. The continuity test system according to claim 11, including a plurality of said continuity test units.

16. The continuity test system according to claim 12, including a plurality of said continuity test units.

17. The continuity test system according to claim 13, including a plurality of said continuity test units.

18. The continuity test system according to claim 14, including a plurality of said continuity test units.
